(19) United States
(12) Patent Application Publication
(10) Pub. No.: US 2019/0179294 A1
(43) Pub. Date: Jun. 13, 2019

(54) WORKFLOW CONTROL SYSTEM

(71) Applicant: Raptor Rig, Inc., Calgary (CA)

(72) Inventor: Reginald Waye Layden, Calgary (CA)

(73) Assignee: Raptor Rig, Inc., Calgary, AB (CA)

(21) Appl. No.: 16/093,111

(22) PCT Filed: Apr. 11, 2017
(86) PCT No.: PCT/CA2017/050444

§ 371 Date: Oct. 11, 2018

Related U.S. Application Data
(60) Provisional application No. 62/321,012, filed on Apr. 11, 2016.

(51) Int. Cl. G05B 19/418; G05B 19/048; G05B 23/02

(52) U.S. Cl. CPC G05B 19/41865; G05B 23/0286; G05B 19/048; G05B 19/4185

(57) ABSTRACT

A workflow management system which comprises an interface between an application and a control system to allow interlocks from either the application or the control system to prevent movement to the next step of workflow if the previous step was not confirmed complete by either the application or the control system.

### CROSS-REFERENCE TO RELATED APPLICATIONS

This application is a national phase application of PCT/CA2017/050444, filed Apr. 11, 2017; which claims the benefit of U.S. Provisional Patent Application No. 62/321,012, filed Apr. 11, 2016, both of which are hereby incorporated by reference in their entirety.

### FIELD

The disclosure relates generally to workflow control. The disclosure relates specifically workflow control systems.

### BACKGROUND

Workflow control, including Standard Operating Procedures (SOPs), have historically been either paper or electronic view only files. The worker completes the workflow with no control system interaction.

It would be advantageous for there to be a workflow management mechanism capable of preventing the next action being performed until it has been confirmed that the previous action was completed.

### SUMMARY

An embodiment of the disclosure is a workflow management system comprising an interface between an application and a control system to allow interlocks from either the application or the control system to prevent progression beyond a step of a workflow if a condition for completion has not been met. In an embodiment, the workflow management system further comprises logging activities performed in the application or by the control system; and making the activities available for reporting and analysis. In an embodiment, when a safety meeting requirement is present in a workflow, the safety meeting is initiated, managed, and recorded in the system. In an embodiment, the initiating, managing, and recording is performed by the application user; and the control system uses the safety meeting requirement as an interlock to prevent progression to the next step of the workflow. In an embodiment, the workflow management system further comprises an override system to allow users with appropriate permissions to override conditions that prevent progression through the steps of the workflow. In an embodiment, the override can be requested and granted by users from at least one of the group consisting of a server application, the control system, and a mobile application. In an embodiment, the control system comprises at least one sensor. In an embodiment, the at least one sensor confirms the state of a piece of equipment. In an embodiment, the at least one sensor confirms that the equipment is in the state the user of the app indicates prior to moving on to the next step. In an embodiment, the control system is accessed by a smart device. In an embodiment, the smart device is a phone or a tablet. In an embodiment, the application is installed on a laptop computer.

An embodiment of the disclosure is a computer application capable of interfacing with the workflow system to perform steps of the SOP while is the user is remote from the control system, and to see the status of SOP steps on demand In an embodiment, the computer application is a server application. In an embodiment, the computer application is a mobile application. In an embodiment, the computer application is installed on a smart device. In an embodiment, the smart device is a phone or tablet. In an embodiment, the application is installed on a laptop computer. In an embodiment, the computer application further comprises a site-wide alert system based on the state of workflows. In an embodiment, the site-wide alert system prevents a user from proceeding to the next step of the workflow.

An embodiment of the disclosure is a control system comprising an interface between and a control system to allow interlocks from either the application or the control system to prevent movement to the next step of a standard operating procedure if the previous step was not confirmed complete by either the app or the control system.

An embodiment of the disclosure is a computer application capable of interfacing with the control system.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 depicts a communication flow chart initiated in the software application;

FIG. 2 depicts a communication flow chart initiated by the controller; and

FIG. 3 depicts a communications diagram.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

1. The integration of a smart device or computer application and a control system so that both provide workflow adherence to ensure the safety of workers and to protect equipment. In an embodiment, the workflow is a Standard Operating Procedure (SOP). In an embodiment, the smart device is a phone, tablet, or any similar electronic device. This integration is accessible and manageable from any location. This requires the development of an interface between an application (app) and a control system to allow interlocks from either the app or the control system to prevent movement to the next step of a workflow if the previous step was not confirmed complete by either the app or the control system. In an embodiment, the control system comprises a controller. The control system uses sensors to physically confirm that the equipment is in the state the user of the app indicates prior to moving on to the next step. This process integrates both real world sensors and portable access to the system status to ensure that the workflow has been followed prior to completing a task to promote safety and to protect equipment.

2. Technology interface to improve the safety of workers and protect equipment. The development of an app that can operate on a smart device or a desktop/laptop operating system and an interface to communicate with a control system. The app and control system interface would allow for interaction between mobile or desktop technology and control systems to ensure that workflow steps are followed and critical steps confirmed by the control system to ensure the safety of workers and protection of equipment. The interface between the app and control system is crucial to elevating the effectiveness of the workflow.

3. Mobile software applications and control systems currently operate in isolation. Creating an interface to share interlocks between an app and a control system would elevate the safety of workers and protection of equipment. The app would replace the paper or electronic workflow steps (including but not limited to a SOP) and interface with the control system to ensure that steps of the SOP are completed and confirmed before moving on to the next step. Only when the worker and the control system confirm that the conditions of the workflow have been met will the control system allow the worker to operate the piece of equipment and progress through the workflow steps. Tracking of the completion of the steps would be stored within the app database for tracking and further training This system would allow for a true double check to ensure all equipment is in a safe state before operating.

In an embodiment, the application can be used on a smart device including but not limited to a phone, tablet, or iPad. In an embodiment, the application can be used on a laptop or desktop computer.

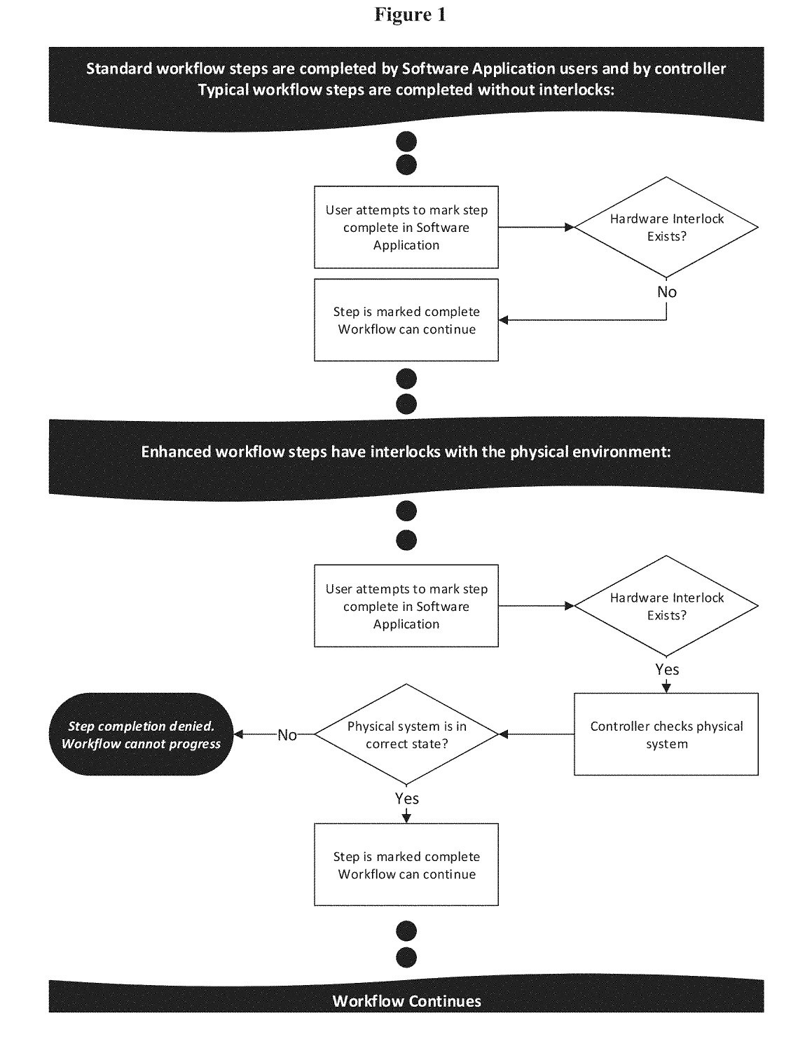

FIG. 1 depicts a communication flow chart with workflow steps initiated in the software application.

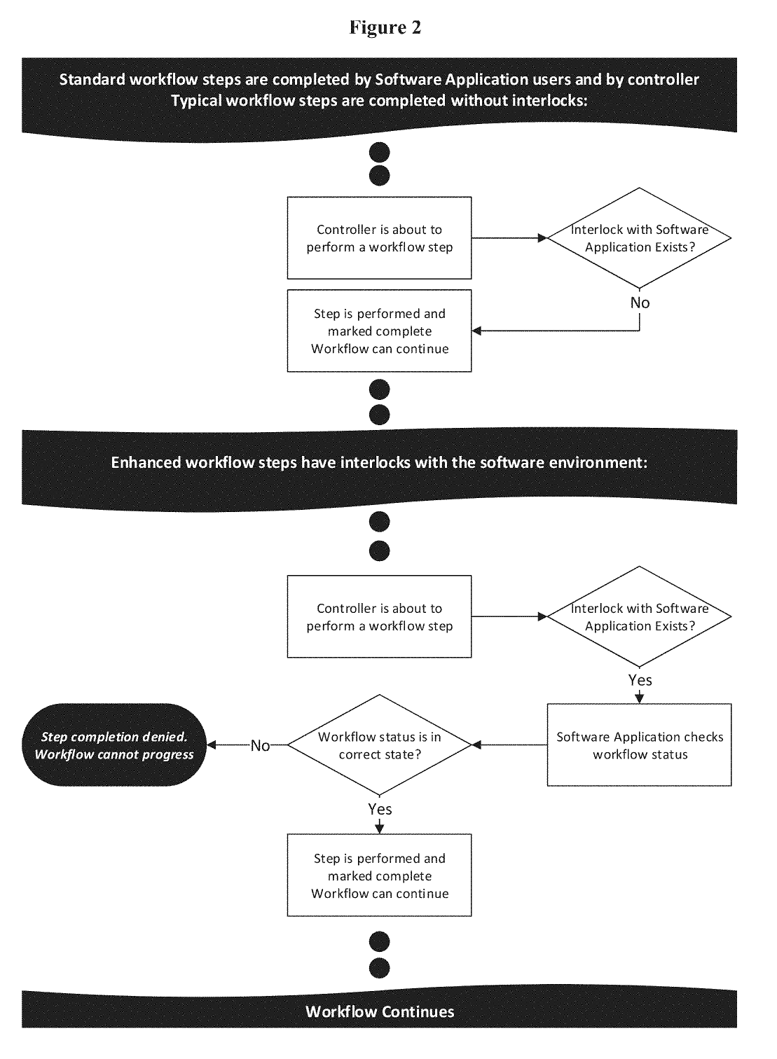

FIG. 2 depicts a communication flow chart with workflow steps initiated by the controller.

The integration of an application and a control system allows the workflow control system to improve compliance with any rules, including compliance with standard operating procedures. In an embodiment, the workflow control system is for a drilling rig. In an embodiment, the workflow control system is for any process or equipment that requires compliance to a given set of rules. In an embodiment, industries for which the workflow control system can be utilized include but are not limited to oil and gas, forestry, power, waste water, manufacturing, or any industry that has processes (organized steps) and machines that can interact with each other.

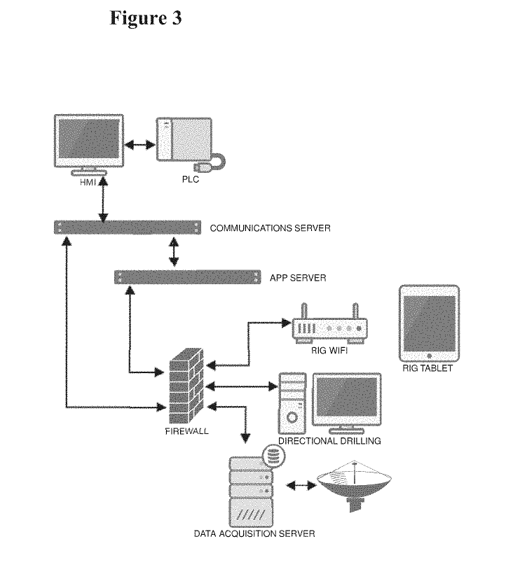

FIG. 3 depicts a communications diagram. In an embodiment, the programmable logic controller (PLC) and the human machine interface (HMI) can communicate back and forth. The PLC monitors the state of the input devices and makes decisions based upon a program to control the state of output devices. In an embodiment, the HMI and a communications server can communicate. In an embodiment, the HMI and an app server can communicate. In an embodiment, the communications server and the app server can communicate. In an embodiment, the communications server and the app server can each communicate with various equipment to physically confirm that the equipment is in the state the user of the app indicates prior to moving on to further steps. In an embodiment, at least one sensor is used to detect the state of one or more pieces of equipment. In an embodiment, the equipment can include but is not limited to a data acquisition server, directional drilling, rig wi-fi, and rig tablets. In an embodiment, the sensors can detect whether certain equipment is powered on or off, whether an inspection has occurred, whether lubrication has occurred, pressure levels, and flow levels. In an embodiment, whether an operator has marked an activity as performed can be monitored as part of the present system.

In an embodiment, the workflow steps can include but is not limited to whether an operator has completed required training, whether the operator is wearing proper safety equipment, whether an inspection has occurred, whether equipment has been lubricated, whether any fluids needed are present, whether drilling mud is present, whether water is present, whether there are any engine warnings, whether there are any high temperature warnings, whether the necessary number of winch line wraps are present, whether necessary equipment guards are in place, whether any hoses are leaking, whether necessary Material Safety Data Sheets have been reviewed, whether the correct size of tubular is being utilized, and whether the proper number of personnel are present to operate the equipment.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain aspects which are related can be substituted for the aspects described herein while the same or similar results would be achieved. All such similar substitutes and modifications apparent to those skilled in the art are deemed to be within the spirit, scope and concept of the disclosure as defined by the appended claims.

What is claimed is:

1. A workflow management system comprising
an interface between an application and a control system to allow interlocks from either the application or the control system to prevent progression beyond a step of a workflow if a condition for completion has not been met; and
a safety feature preventing progression beyond a step of a workflow unless all tasks within a step are confirmed by the user through the application.

2. The workflow management system of claim 1 further comprising logging activities performed in the application or by the control system; and making the activities available for reporting and analysis.

3. The workflow management system of claim 1 wherein when a safety meeting requirement is present in a workflow, the safety meeting is initiated, managed, and recorded in the system.

4. The workflow management system of claim 3 wherein the initiating, managing, and recording is performed by the application user; and
the control system uses the safety meeting requirement as an interlock to prevent progression to the next step of a workflow.

5. The workflow management system of claim 2 further comprising an override system to allow users with appropriate permissions to override conditions that prevent progression through the steps of the workflow.

6. The workflow management system of claim 5 wherein the override can be requested and granted by users from at least one group consisting of a server application, the control system, and a mobile application.

7. The workflow management system of claim 1 wherein the control system comprises at least one sensor.

8. The workflow management system of claim 7 wherein the at least one sensor confirms the state of a piece of equipment.

9. The workflow management system of claim 8 wherein the at least one sensor confirms that the equipment is in the state the user of the app indicates prior to moving on to the next step.

10. The workflow management system of claim 1 wherein the control system is accessed by a smart device.

11. The workflow management system of claim 8 wherein the smart device is a phone or a tablet.

12. The workflow management system of claim 1 wherein the application is installed on a laptop computer.

13. A computer application capable of interfacing with the workflow system of claim 1, to perform steps of the SOP while the user is remote from the control system, and to see the status of SOP steps on demand.

14. The computer application of claim 13 wherein the computer application is a server application.

15. The computer application of claim 13 wherein the computer application is a mobile application.

16. The computer application of claim 13 wherein the computer application is installed on a smart device.

17. The computer application of claim 16 wherein the smart device is a phone or tablet.

18. The computer application of claim 13 wherein the application is installed on a laptop computer.

19. The computer application of claim 13 further comprising a site-wide alert system based on the state of workflows.

20. The computer application of claim 19 wherein the site-wide alert system prevents a user from proceeding to the next step of the workflow.
